(19) United States
(12) Patent Application Publication
(10) Pub. No.: US 2008/0236021 A1
(43) Pub. Date: Oct. 2, 2008

(54) Cup holder rod and reel mount

(76) Inventor: Brian L. McNamire, Garland, TX (US)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/727,597

(22) Filed: Mar. 27, 2007

(51) Int. Cl. A01K 97/10; A01K 97/00

(52) U.S. Cl. 43/21.2

(57) ABSTRACT

A fishing rod mount is described wherein said mount comprises a base portion and a rod holder. The base portion is configured for secure receipt within a cylindrical cup holder, and said rod holder is capable of securely maintaining a fishing rod.

### BACKGROUND OF THE INVENTION

1. Field of the Invention

The present invention generally relates to a mount for a fishing rod and reel and, more particularly, to a mount adapted to securely fit in a standard cup holder.

2. Description of Related Art

Individuals who enjoy fishing, whether for sport or leisure, typically must continuously manually handle and/or monitor their fishing rods for extended periods of time between casts and/or fish strikes. Often, such handling and/or monitoring becomes burdensome or undesirable in view of other activities requiring the attention of the individual. Further, it is often desired on the part of the individual to cast lines from multiple fishing rods simultaneously so as to increase the likelihood of catching fish.

Given the desirability on the part of individuals who enjoy fishing to at least temporarily release their fishing rods and/or pause in the monitoring of such rods, assorted and miscellaneous known devices have been created for the securement of rods while fishing in lieu of traditional manual handling.

By way of example, U.S. Pat. No. 7,131,232 discloses a clamped rod holder for quickly and easily releasibly securing a rod; U.S. Pat. No. 7,114,281 discloses a base-mountable rod holder; U.S. Pat. No. 6,681,517 discloses a fishing rod holder for mounting under a seat pedestal; U.S. Pat. No. 6,497,067 discloses a rod holder including a mechanism for securing the holder between the planks of a wooden fishing pier; and U.S. Pat. No. 5,205,446 discloses a trailer hitch-mounted fishing pole holder.

Commonly, individuals fish from boats which are equipped with depressed cylindrical cup or beverage holders. Such cup or beverage holders are generally standard in their dimensions, being slightly larger in diameter than a common 12 ounce beverage can or bottle. In view of the need on the part of those who fish to secure their rod(s), there is a need for a fishing rod holder adapted to securely fit in a standard cup holder.

### BRIEF SUMMARY OF THE INVENTION

In view of the known prior art fishing rod holders, the present invention provides a rod holder comprising a base adapted to fit securely within a standard cup holder. The rod holder further comprises a rod holding seat for releasably securing a fishing rod. The rod holding seat of the present invention may optionally be removable from said base and/or capable of rotating and/or pivoting about said base.

The features of the present inventive rod holder provide convenience and utility to individuals who enjoy fishing by allowing such individuals to releasably secure their fishing rods as desired. The objects and benefits set forth herein are not exhaustive, and are not intended to limit the scope of the invention disclosed and claimed herein. Many other applications, benefits, and advantages of the present invention will be appreciated by those of skill in the art. A further understanding of the present invention may be had by referring to the following Detailed Description of the Preferred Embodiment.

### BRIEF DESCRIPTION OF THE DRAWINGS

Various preferred embodiments of the current invention are further described and explained in relation to the following figures wherein:

FIG. 1 is an elevation view of a rod mount embodiment in accordance with the present invention;

FIG. 2 is a perspective view of a base portion of a rod mount in accordance with the present invention;

FIG. 2A is a perspective view of a base portion of a rod mount in accordance with the present invention; and

FIG. 3 is perspective view of a collet of a rod mount in accordance with the present invention.

### DETAILED DESCRIPTION OF THE PREFERRED EMBODIMENT

The preferred and alternative embodiments of the present invention as described and illustrated herein are illustrative only, and are not intended to limit the scope of the present invention. Those of skill in the art will recognize a multitude of uses for, and equivalent variations of, the present invention.

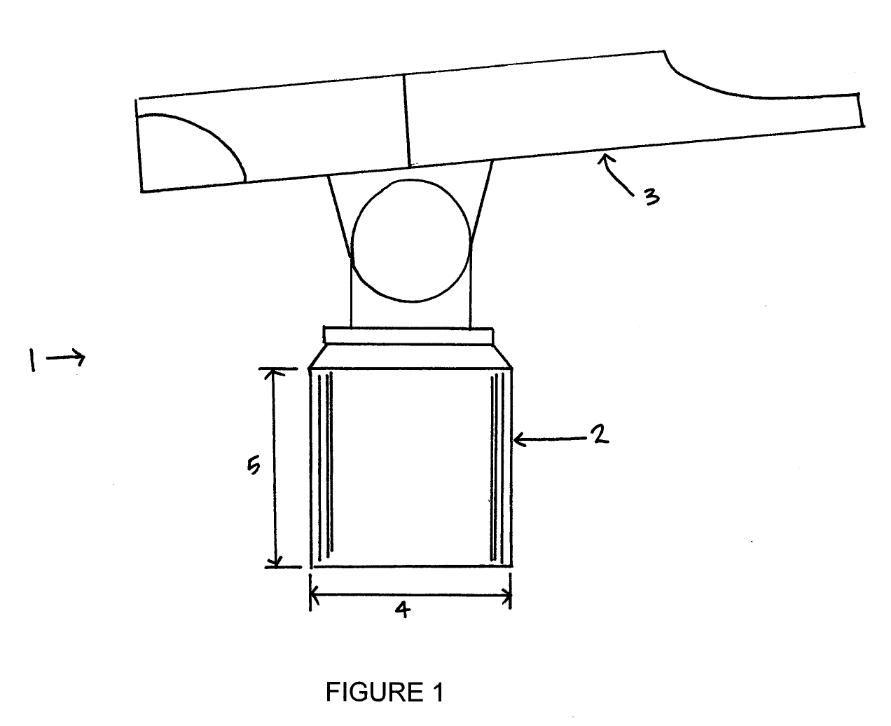

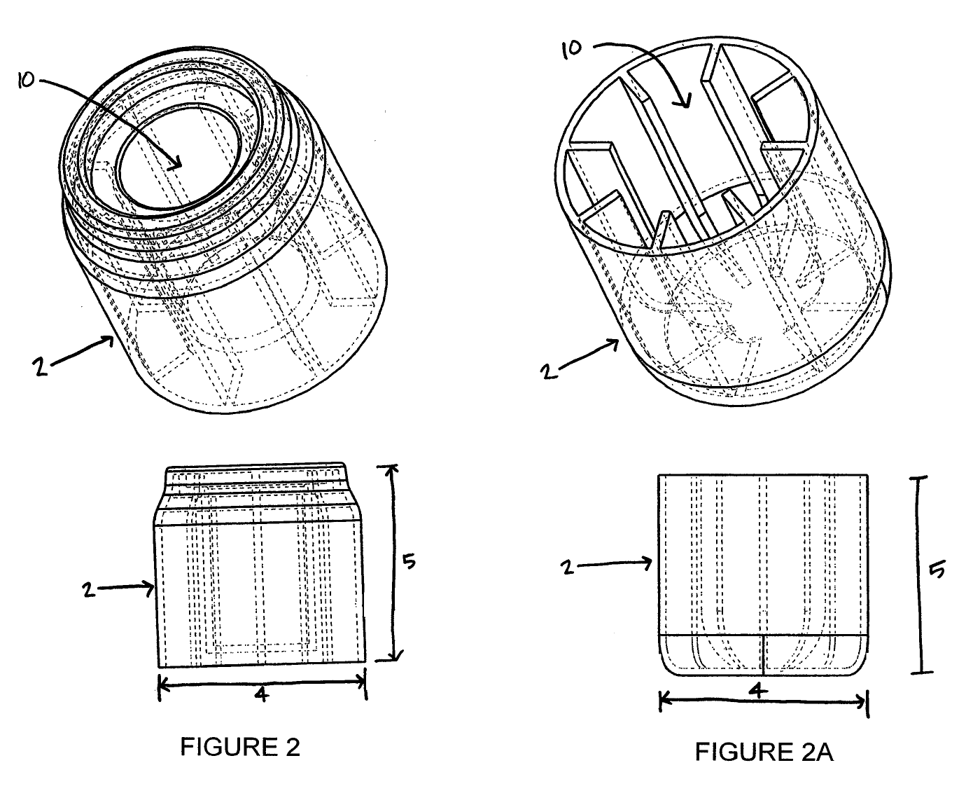

Referring now to FIG. 1, an elevational view of a rod mount embodiment in accordance with the present invention is shown. Mount 1 comprises base portion 2 and rod holder 3. As illustrated best in FIGS. 2 and 2A, base portion 2 is preferably cylindrical in shape, being apportioned such that it is capable of fitting securely within a standard cup holder. Preferably, the outer diameter 4 of base portion 2 is about 2.6 inches, and base portion 2 is about 2.5 inches in height 5. It has been found that molded nylon is an acceptable material for the manufacture of mount 1, although base portion 2 can be of any acceptable material, such as foam, rubber, or plastic. Of course, base portion 2 need not be cylindrical, as long as it includes flanges, projections, legs, sides, edges, or surfaces capable of fitting securely within a standard cup holder. Further, base portion 2 may be of significantly differing heights, but preferably within the range of 2 inches to 6 inches. Of course, given the range of sizes available for cup holders, base portion 2 may be apportioned accordingly, but in any event is between 2 and 5 inches in outer or diametrical dimension 4.

Rod holder 3 of mount 1 may be either integrally molded with, secured to, or otherwise adapted for coupling with, base portion 2. For example, rod holder 3 may include a first threaded portion 6 for interconnecting rod holder 3 to a second threaded portion 7 of base portion 2. Alternatively, rod holder 3 may include an extension 8 configured to be securely received by an opening 9 in base portion 2. Rod holder 3 is configured such that it securely and releasably receives a fishing rod, preferably the handle portion of said rod. Various means for releasably securing the handle portion of a fishing rod are known in the art, and any method by which said rod is secured is acceptable without detracting from the present invention.

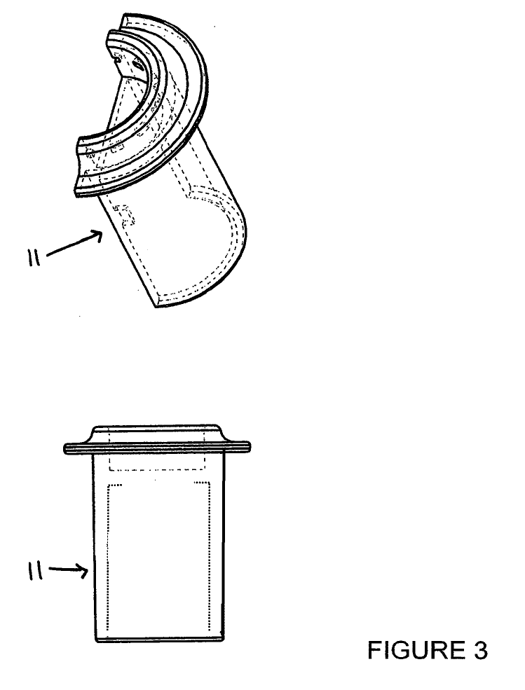

Still in the alternative, base portion 2 may include interior cavity 10. As illustrated in FIG. 3, collet 11 may be further provided to fit securely within cavity 10. Collet 11 is configured to securely receive extension 8 of rod holder 3. Of course, as stated, rod holder 3 may be optionally integrally molded with base portion 2.

Rod holder 3 may be pivotally and/or rotatably mounted to base portion 2. In other words, rod holder 3 may be configured such that it is capable of rotation and/or pivoting movement in order to accommodate the needs of the user.

Having thus described preferred embodiments of the present invention, it is recognized that those of skill in the art will appreciate the several advantages inherent in the present invention over the prior art. It is further recognized that those of skill in the art will appreciate the various configurations which may be employed in making and/or using an adapted cup holder rod and reel mount in accordance with the present invention without limitation. All embodiments falling within the scope of the appended claims are therefore considered part of the present invention, as are equivalents thereof.

What is claimed is:

1. A fishing rod mount comprising:
a base portion configured for secure receipt within a cylindrical cup holder; and
a rod holder for securely maintaining a fishing rod.

2. A fishing rod mount according to claim 1, wherein:
said base portion is cylindrical.

3. A fishing rod mount according to claim 2, wherein:
said base portion is about 2.6 inches in outer diameter.

4. A fishing rod mount according to claim 2, wherein:
said base portion is about 3.5 inches in outer diameter.

5. A fishing rod mount according to claim 1, wherein:
said base portion and said rod holder are integrally molded.

6. A fishing rod mount according to claim 1, wherein:
said rod holder is rotatable about said base portion.

7. A fishing rod mount according to claim 1, wherein:
said rod holder is pivotable about said base portion.

8. A fishing rod mount according to claim 6, wherein:
said rod holder is pivotable about said base portion.
